(19) United States
(12) Patent Application Publication
(10) Pub. No.: US 2012/0230668 A1
(43) Pub. Date: Sep. 13, 2012

(54) Camera system including six rotational axes for moving a camera

(75) Inventor: Gerald Vogt, Lathuile (FR)

(73) Assignee: Staubli Faverges, Faverges (FR)

(21) Appl. No.: 13/412,658

(22) Filed: Mar. 6, 2012

Related U.S. Application Data
(60) Provisional application No. 61/449,858, filed on Mar. 7, 2011.

(30) Foreign Application Priority Data
Mar. 7, 2011 (DE) 20 2011 003 666.9

(51) Int. Cl. G03B 17/56

(52) U.S. Cl. 396/428

(57) ABSTRACT

The present invention relates to a camera system having six axes of rotation for moving a camera. The camera system includes a camera robot and a tilt head for receiving and holding a camera, typically a television camera. The camera robot has an arm having five axes of rotation; the tilt head is fastened to the arm by means of a flange. The tilt head itself has only one axis of rotation which is configured for tilting the camera about this axis of rotation. The control of the tilt head is particularly simple with only one axis of rotation at the tilt head, particularly since a panning of the tilt head can take place through one of the axes of rotation on the arm and the tilt head can thus also be freely moved into different positions.

### RELATED APPLICATION

This application claims the benefit, under 35 U.S.C. 119(e), of the provisional application filed Mar. 7, 2011 under 35 U.S.C. 111(b), which was granted Ser. No. 61/449,858. This provisional application is hereby incorporated by reference.

### BACKGROUND OF THE INVENTION

The present invention relates to a camera system having six axes of rotation for moving a camera.

Camera systems for use in television studios are already known from the prior art. WO 2007/065676 A1 thus discloses a camera robot having eight axes of rotation of which two axes of rotation extend through a pan/tilt head for panning and tilting a camera. A disadvantage of such an arrangement is the number of axes of rotation which have to be controlled, particularly since the camera robot is overdetermined with eight axes of rotation since a movement can only be carried out in the six spatial coordinates. Unnecessary calculation effort is thus undertaken to control the movement about the axes of rotation. In addition, a separate motor has to be provided for each of these axes of rotation, which increases the weight of the camera robot, particularly since the robot arm must also thereby have a much greater weight.

### SUMMARY OF THE INVENTION

It is thus the underlying object of the present invention to develop a camera system which avoids the named disadvantages, with which therefore a full freedom of movement of a camera robot is ensured with a minimum number of axes of rotation and which is therefore simple to control.

This object is achieved in accordance with the invention by a camera system in accordance with claim 1.

A camera system having six axes of rotation for moving a camera includes a camera robot and a tilt head for receiving and holding a camera, typically a television camera. The camera robot has an arm having five axes of rotation; the tilt head is fastened to the arm by means of a flange. The tilt head has only one axis of rotation which is configured for tilting the camera about this axis of rotation.

Such a camera system has the advantage that the six axes of rotation can be controlled by a conventional controller for industrial robots since industrial robots typically have six axes of rotation. An adaptation of the control unit controlling the camera system to the system used is thus not necessary, which saves effort and thus costs. A camera system in accordance with the invention furthermore has full freedom of movement with a number of axes of rotation which is as small as possible. This is accompanied by a weight reduction since as a rule a motor is required on the arm for each axis of rotation. The control of the tilt head is particularly simple with only one axis of rotation at the tilt head, particularly since a panning of the tilt head can take place through one of the axes of rotation on the arm and the tilt head can thus also be freely moved into different positions.

Advantageous further developments of the camera system are described in the dependent claims.

In an embodiment, at least two of the five axes of rotation of the camera robot extend parallel to one another. A rough setting of the position can be carried out through one axis and a fine setting can be carried out through the axis extending parallel thereto thanks to axes of rotation extending in parallel. This allows a fast, but simultaneously precise traveling to the desired position.

In an advantageous embodiment, three of the five axes of rotation extend parallel to one another in the horizontal direction. A vertical setting of the tilt head and thus of the camera can thereby be carried out simply in that each of the axes of rotation allows a respectively ever finer positioning of the tilt head with respect to a surface on which the camera robot stands. In addition to a vertical setting, a horizontal positioning of the tilt head can hereby also be carried out.

In a particularly advantageous embodiment, the angle sum of the three axes of rotation extending parallel to one another in the horizontal direction is constant. The constant angle sum provides a kind of “elevator effect” for the vertical setting through the horizontally extending axes in that a rotation about a specific angle of an axis of rotation results in a corresponding rotation of another axis of rotation and thus the height can be set particularly simply and fast.

Provision can moreover be made that two of the five axes of rotation extend parallel to one another in the vertical direction. A rough setting and a fine setting of a panning range of the camera system is achieved by this embodiment which in particular allows an exact and fast traveling to any desired positions in combination with three axes of rotation extending parallel to one another in the horizontal direction.

In an embodiment, two of the five axes of rotation extend through an end of the arm. These two axes of rotation are in this respect preferably perpendicular to one another. The end of the arm to which the tilt head is fastened by means of a flange can be used for the fine setting of the alignment of the tilt head through two axes of rotation. Since the axes of rotation extending through the end are perpendicular to one another, a positioning of two different directions of movement is made possible, for example panning and tilting.

The axis of rotation for tilting the camera and an axis of rotation extending through the end of the arm in the vertical direction can be perpendicular to one another. The tilt is hereby effected by the axis of rotation extending through the tilt head, while the panning of the tilt head can be set by the axis of rotation extending perpendicular thereto. The tilt head itself, however, has only one axis of rotation so that also only one motor has to be attached for tilting at the tilt head, while simultaneously the full freedom of movement of panning and tilting is ensured by the axis of rotation extending through the end of the arm.

An embodiment provides that the axis of rotation for tilting the camera and an axis of rotation extending through the end of the arm in the vertical direction intersect. A coordinate transformation between a coordinate system of the tilt head and a coordinate system of the camera robot can be carried out particularly simply by the common point of intersection of the two axes and a point of rotation defined thereby about which the tilt head can be tilted and panned.

Provision can be made in a further embodiment that the axis of rotation for tilting the camera lies in a focal plane of the camera received by the tilt head. Since the focal plane and the optical axis of the camera are by definition perpendicular to one another, the optical axis and the axis of rotation for tilting the camera are thus perpendicular on one another and are arranged in a fixed ratio to one another. This in turn allows a simplification of the coordinate transformation.

The axis of rotation extending through the end of the arm in the vertical direction and the axis of rotation for tilting the camera can intersect on the optical axis of a camera lens. In this case, two axes of rotation and the optical axis intersect at one point and are each perpendicular on one another, which allows a very particularly simple coordinate transformation and thus also a simple control of the tilt head.

The camera robot of the camera system can include a base unit, a shoulder unit, an upper arm, an elbow joint and a lower arm. The lower arm, the elbow joint and the upper arm in this respect form the arm. The shoulder unit can be fastened rotatably about a first one of the axes of rotation on the base unit; the upper arm can be fastened rotatably about a second one of the axes of rotation at the shoulder unit; and the lower arm can be fastened via the elbow joint to the upper arm rotatably about a third one of the axes of rotation. The tilt head can finally be fastened to the lower arm with a flange via a wrist joint rotatable about a fourth one of the axes of rotation, and about a fifth one of the axes of rotation, with the rotatable wrist joint being located at the end of the arm. The axes of rotation are therefore associated with individual components of the camera robot and in particular the position of the axes of rotation extending through the end of the arm are defined in relation to the other axes of rotation.

An advantageous embodiment provides that the lower arm includes two segments connected to one another and tilted about a fixed angle with respect to one another. Additional space for the reception of the tilt head in the highest position of the camera robot is provided by this embodiment when the tilt head is held below the arm. Without such a design, i.e. with a straight design of the lower arm, the highest possible position of the arm could admittedly be traveled to by extending the arm, but the tilt head would be very limited in its freedom of movement due to the mechanical contact with the arm. Due to the tilting of the segments, the tilt head can be received in the cut-out defined by the mutually tilted segments so that it can also still be tilted and panned in the completely extended highest position of the arm.

The camera robot can in each case have a preferably brushless motor for a rotation about a respective one of the axes of rotation. A separate control of each axis of rotation by a motor which is typically fastened beneath a cover of the camera robot takes place by a respective motor for each of the axes of rotation. Each motor is preferably directly attached at the position of the axis of rotation. Vibrations caused by the motor are reduced by a brushless motor so that images taken by the camera are also not impaired by vibrations.

Provision can be made in an embodiment that the first axis of rotation and the fifth axis of rotation extend in the vertical direction and/or the second axis of rotation, the third axis of rotation and the fourth axis of rotation extend in the horizontal direction. The vertical setting can be carried out in a precise manner by three mutually adjacent axes of rotation, while the first axis of rotation can be used for a rough panning and the fifth axis of rotation for a fine setting of the panning.

The camera system can include a control unit which respectively has a control for controlling each of the motors and a processor for controlling the controls. The control unit thus takes over the control of the total camera system in manner such that each of the typically six motors is controlled by a separate control for each axis of rotation, but that these controls are in turn controlled centrally by a processor. This allows a particularly simple, but nevertheless precise, control of the movements of the camera robot.

Provision is made in an advantageous embodiment that the control unit is configured to keep the angle sum of three axes extending parallel constant. This allows the already described simple setting of the height of the tilt head.

The control unit can moreover be configured to ensure a vertical position of a further axis extending through the end of the arm. An axis is thus kept vertical by the control unit in addition to a vertical setting by the constant angle sum, whereby the panning range is also preset in a defined manner.

The camera system can include a movable platform on which the camera robot is mounted. Due to the movable platform, the camera robot is not only rotatable, but also movable in translation and can be traveled to different positions.

The movable platform can also include the control unit so that all essential components of the camera system, that is the camera robot with the tilt head, the control unit and the movable platform, are combined in a compact manner in one assembly and can thus be moved without problem.

The movable platform has an air cushion in an advantageous further development. The air cushion, on the one hand, allows the movement of the movable platform, but can, on the other hand, also be used to damp vibrations. In addition to or instead of the air cushion, a vibration damping can also be provided by a spring mechanism.

In an embodiment, the movable platform has at least two wheels which can preferably be controlled automatically—typically via the control unit. The movable platform can be traveled either on rails or independently of rails by the wheels. The control of the wheels via the control unit allows a control of the complete camera system by a device operable by a user.

The camera system can have a safety system which is designed so that a safety distance of the camera system from other objects is observed. For this purpose, the safety system can include distance sensors, for example laser-based distance sensors, which detect a distance from other objects such as persons or objects and stop the movement of the camera system in order not to risk injury to persons or damage to the camera system or other objects.

Provision is made in an embodiment that a screen is attached to the tilt head. A screen is thus attached in the direct vicinity of the camera which can be used, for example, as a teleprompter for a presenter or to monitor the image taken by the camera. It is particularly advantageous here that the screen is always moved along with the tilt head and thus with the camera, that is it is always visible on recording.

The camera system can have an apparatus for taking and processing gestures of a user and the camera robot itself can be controlled by the gestures.

The processing of the gestures can also take place in the control unit which also takes over the control of the camera robot. The camera robot can hereby be controlled without additional manually operable control units, which simplifies operation.

In an embodiment, the camera system has a device for receiving and processing acoustic signals, with the camera robot being controllable by the acoustic signals. The processing of the acoustic signals can take place in the control unit. The control via acoustic signals, for example voice commands, simplifies the operation of the camera system since a manually actuable operating device can be dispensed with.

The camera system can have a manual operating device for controlling the movement of the camera robot or for operating the camera system. In particular a joystick can be considered for this purpose. Trajectories of the camera robot can hereby be programmed and retraced simply by a corresponding setting of the operating device. In addition, the camera system can be controlled by a conventional operating concept.

The camera system can also be controllable via a remote control. As a result no persons are required for controlling in the direction vicinity of the camera system during recording, which considerably reduces the personnel requirements and whereby the camera system can be operated more independently.

Embodiments of the invention are shown in the drawings and will be explained in the following with reference to FIGS. 1 to 18.

### BRIEF DESCRIPTION OF THE DRAWINGS

There are shown:

FIG. 1 a perspective view of a camera system with a tilt head and axes of rotation drawn in;

FIG. 2 a side view of a camera robot with a tilt head;

FIG. 3 a side view of the camera robot shown in FIG. 2 with a tilt head and an arm completely extended in the horizontal direction;

FIG. 4 a representation of the camera robot corresponding to FIG. 3 in which the tilt head was tilted downwardly with the camera;

FIG. 5 a representation corresponding to FIG. 3 of the camera robot with a panned tilt head;

FIG. 6 a side view of the camera robot with a tilt head shown in FIG. 2 with an extended arm;

FIG. 7 a side view of a camera robot with a tilt head with a lower arm of two mutually tilted segments;

FIG. 8 a perspective view of a camera robot with a tilt head with an arm moved into a low position;

FIG. 9 a perspective view of a tilt head with a camera and screen;

FIG. 10 a perspective view of a tilt head without a camera and screen;

FIG. 11 a perspective view of the lower side of a camera robot with a tilt head and a movable platform;

FIG. 12 a camera system with a camera robot, a control unit and a movable platform as well as with an acoustic control;

FIG. 13 a view corresponding to FIG. 12 of a camera system with a gesture-based control;

FIG. 14 a perspective view of a camera system with various operating units;

FIG. 15 a side view of a safety system of a camera system;

FIG. 16 a perspective view of a safety system of a camera system;

FIG. 17 a perspective view of a camera system with cylinder coordinates entered; and

FIG. 18 a perspective view of a camera system with a plurality of coordinate systems transformable into one another.

### DETAILED DESCRIPTION OF THE INVENTION

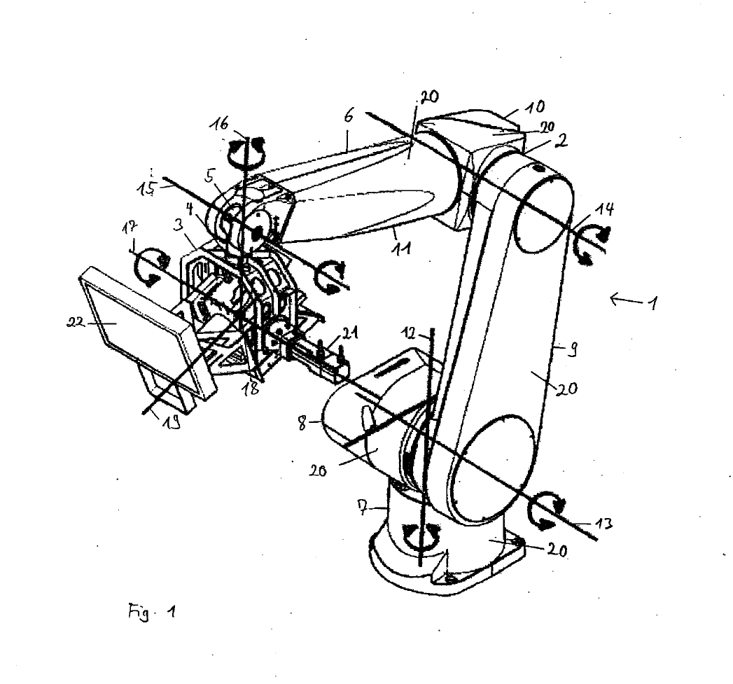

A camera system 1 which includes a camera robot 2 and a tilt head 3 is shown in a perspective view in FIG. 1. The tilt head 3 can receive a camera and is fastened to an arm 6 of the camera robot 2 by means of a flange 4 at a wrist joint 5. The camera robot 2 includes a base unit 7, a shoulder unit 8, an upper arm 9, an elbow joint 10 and a lower arm 11.

The upper arm 9, the elbow joint 10 and the lower arm 11 form the arm 6 of the camera robot 2. The shoulder unit 8 is rotatably fastened on the base unit 7 about an axis of rotation 12; the upper arm 9 is rotatably fastened on the shoulder unit 8 about a second axis of rotation 13. The lower arm 11 is rotatably fastened to the upper arm 9 about a third a ds of rotation 14 via the elbow joint 10. At the end of the arm 6, the fourth axis of rotation 15 and the fifth axis of rotation 16 extend perpendicular to one another by the wrist joint 5, with the wrist joint 5 being fastened to the lower arm 11. The upper arm 9 is positioned spatially offset from the first axis of rotation 12. The lower arm 11 lies in a plane which is defined by the first axis of rotation 12 and an axis standing perpendicular on both the first axis of rotation and on the second axis of rotation 13 and to which the upper arm 9 extends in parallel. The wrist joint 5 has only two degrees of freedom due to the fastening to the lower arm 11, namely the fourth axis of rotation 15 and the fifth axis of rotation 16.

The first axis of rotation 12 is freely rotatable about 360° and allows a rough setting of the panning angle. The second axis of rotation 13 and the third axis of rotation 14 are each rotatable about 300®; the fourth axis of rotation 15 is rotatable about 260°. A vertical adjustment of the tilt head 3 takes place through the last-named axes of rotation. The fifth axis of rotation 16 has a rotational range of 360° and serves the fine setting of the panning angle. The sixth axis of rotation 17 is rotatable about 60°.

The tilt head 3 only has the sixth axis of rotation 17 which serves the tilting of the camera fastenable to the tilt head 3. Overall, the camera robot 2 therefore has six axes of rotation 12-17 for moving the camera of which the arm 6 has five axes of rotation 12-16, the tilt head 3 only one further one, namely the sixth axis of rotation 17.

In the embodiment shown, the first axis of rotation 12 and the fifth axis of rotation 16 are arranged parallel to one another and extend in the vertical direction. The second axis of rotation 13, the third axis of rotation 14 and the fourth axis of rotation 15 are arranged parallel to one another and extend in the horizontal direction. The angle sum of the second axis of rotation 13, of the third axis of rotation 14 and of the fourth axis of rotation 15 is constant in order thus to ensure a simple vertical setting of the camera robot 2. Overall, therefore, at least two of the five axes of rotation of the arm 6 of the camera robot 2 are parallel to one another.

The sixth axis of rotation 17 and the fifth axis of rotation 16 extending through the wrist joint 5 in the vertical direction as the end of the arm 6 are perpendicular to one another so that the tilt head 3 can be tilted through the sixth axis of rotation 17 and can be panned through the fifth axis of rotation 16. A further travel range of the tilt head 3 thus results. In the embodiment shown, in particular the fifth axis of rotation 16 and the sixth axis of rotation 17 intersect, which simplifies the coordinate transformation for controlling the movement of the camera robot 2 since the tilt head 3 can be panned and tilted about a defined center of rotation. The coordinate transformation can in this respect include a transformation between a coordinate system of the tilt head 3, a coordinate system of the camera robot 2 and/or a coordinate system outside the camera robot 2 called a global coordinate system. In the embodiment shown in FIG. 1, the point of intersection 18 is in a particularly advantageous manner a threefold point of intersection since not only the fifth axis of rotation 16 and the sixth axis of rotation 17 intersect, but also lie on the optical axis 19 of a camera lens and thus intersect it. The point of intersection 18 is located on the CCD chip of a camera, for example. Since the optical axis 19 always stands perpendicular on a focal plane of the camera lens, the fifth axis of rotation 16 and the sixth axis of rotation 17 thus also intersect in the focal plane of the camera lens. A particularly simple coordinate transformation results from the fixed spatial association of the fifth axis of rotation 16, the sixth axis of rotation 17 and the optical axis 19.

In an embodiment not shown here, the fifth axis of rotation 16 and the sixth axis of rotation 17 do not intersect, but rather have a lateral spacing from one another. The operability of the tilt head 3 is still given hereby; however, the distance has to be taken into account in coordinate transformations.

The camera system 1 includes one respective motor for each of the axes of rotation for carrying out the rotation about one of the axes of rotation. The motors are hidden below a cover 20 of the camera motor 2 and therefore not visible in FIG. 1. The motors for the rotation about the first axis of rotation 12 and about the second axis of rotation 13 are located within the shoulder unit 8. The motor for the rotation about the third axis of rotation 14 is located in the elbow joint 10; the motors for the rotation about the fourth axis of rotation 15 and about the fifth axis of rotation 16 are located within the lower arm 11. The rotation about the sixth axis of rotation 17 is effected via a tilt motor 21 fastened to the tilt head 3. The tilt motor 21 is made, like the other five motors hidden beneath the cover 20, as a brushless motor so that a low-vibration rotation about the respective axis of rotation is possible. The weight the arm 6 has to bear is reduced by the attachment of only the tilt motor 21 to the tilt head 3, while the tilt head 3 simultaneously remains pannable and tiltable. In a further embodiment, an additional transmission, preferably a planet gear, can also be used beside the tilt motor 21. The tilt motor 22 is of the same construction as the motors disposed beneath the cover 20 and can thus be controlled by the same control unit, in particular by a conventional controller for industrial robots. The cover 20 can comprise a plastic or a metal, for example steel or aluminum. The cover ring 20 surrounds, fully or with openings for cable connections or operating elements, in each case both the base unit 7 and the should unit 8, the upper arm 9, the elbow joint 10 and the lower arm 11.

Instead of one respective motor for the movement of the fourth axis of rotation 15 and of the fifth axis of rotation 16, a common motor can also be provided for these two axes of rotation since these axes of rotation intersect in the wrist joint 5. This further reduces the weight which the arm 6 has to bear at its end and thus also reduces vibrations of the arm 6 of the camera robot 2 which can also become noticeable in the image quality of the films and images taken by the camera robot 2.

In addition, a screen 22 is also fastened to the tilt head 3 which serves as a teleprompter for a presenter taken by the camera of the camera system 1.

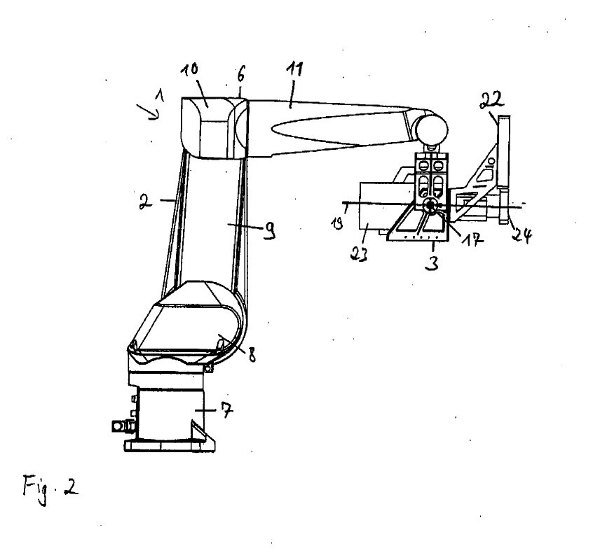

In FIG. 2, a camera system 1 is shown in a side view which, as in FIG. 1, includes a camera robot 2 and a tilt head 3. The structure of the camera robot 2 is identical to the one shown in FIG. 1, i.e. the camera robot 2 again includes the base unit 7, the shoulder unit 8, the upper arm 9, the elbow joint 10 and the lower arm 11. Identical elements are provided with identical reference numerals in this Figure and also in the following Figures.

A camera 23 having a camera lens 24 is fastened to the tilt head 3 via a screw connection or a clamp connection. The optical axis 19 of the camera lens 24 is likewise entered and intersects the sixth axis of rotation 17. The tilt head 3 is held in a horizontal position so that a person taken by the camera 23 can both be taken and read text displayed on the screen 22. The dimensions of the camera robot 2 are therefore selected so that the upper side of the screen 22 is located approximately 2.20 m above the surface on which the base unit 7 stands. The camera 23 moreover has the functions “zoom”, “focus” and “iris”.

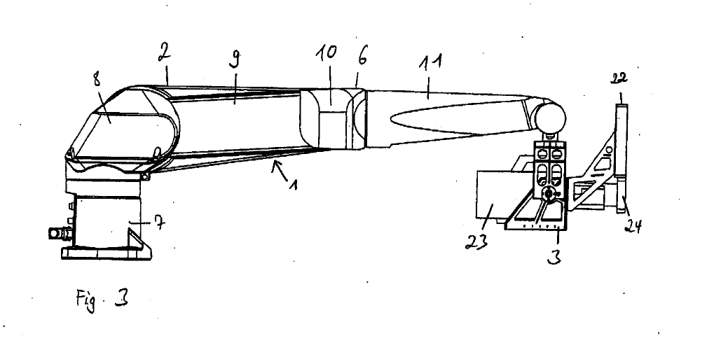

FIG. 3 shows a camera system 1 with a camera robot 2 and a tilt head 3 in a view corresponding to FIG. 2. The arm 6 is now, however, completely extended in the horizontal direction so that it is also possible to travel more closely to objects, in addition to an optical zoom through the camera lens 24 or further optical elements located in the camera 23, by moving the camera robot 2. The traveling takes place via a rotation about the second axis of rotation 13 and the third axis of rotation 14 which are not shown in this Figure for reasons of clarity. The angle sum of these two axes of rotation and of the fourth axis of rotation 15 about which no rotation takes place in the case shown remains constant in this respect; the tilt head 3 is held in a horizontal position as in FIG. 2.

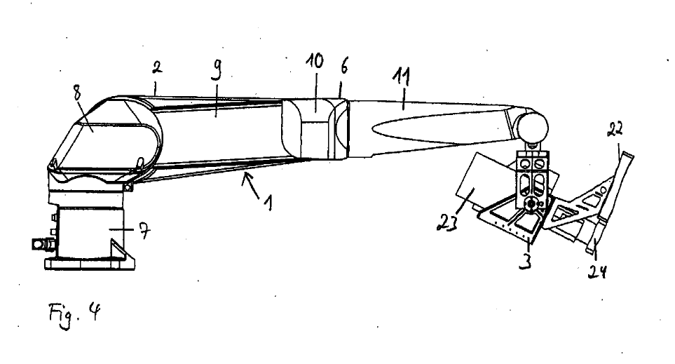

A representation of the camera system 1 corresponding to FIG. 3 with a tilted tilt head 3 is shown in FIG. 4. The tilt head 3 and with it the camera 23 and the screen 22 fastened to it are tilted downwardly by 25° about the sixth axis of rotation 17. The rotation is effected via the tilt motor 21 hidden by the camera 23.

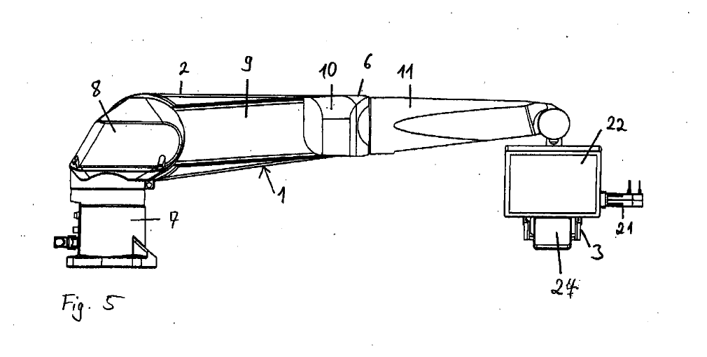

FIG. 5 likewise represents a camera system 1 in accordance with FIG. 3; however, the tilt head 3 and with it the camera 23 and the screen 22 are now panned by 90° so that the camera lens 24 faces the viewer. The panning takes place via the wrist joint 5 which is hidden by the lower arm 11 in FIG. 5 and which is moved by a brushless motor. The camera 23 is located beneath the screen 22.

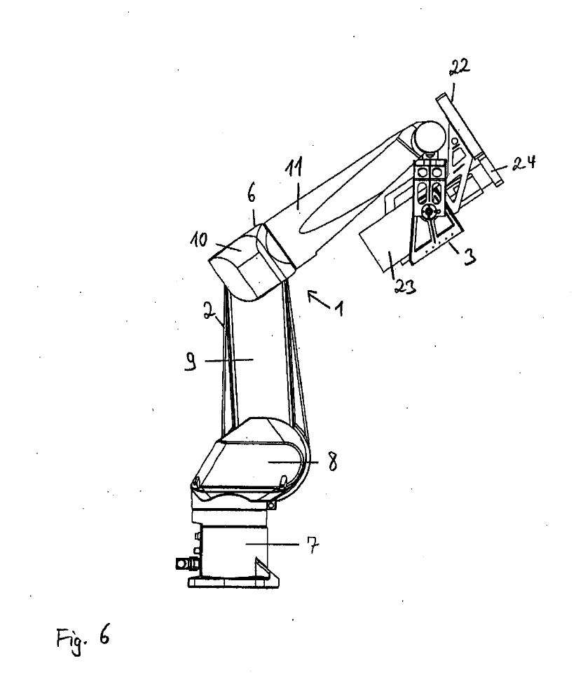

In FIG. 6, a camera system 1 is shown corresponding to that already illustrated in a side view in FIG. 2. The arm 6 is now traveled into the highest reachable position. This is done via a rotation about the second axis of rotation 13 and the third axis of rotation 14 which are not shown in FIG. 6 for reasons of clarity. The angle sum of the horizontally extending axes of rotation also remains constant on this movement. Even if the arm 6 could theoretically be fully extended by a further rotation about the fourth axis of rotation 15, as was also shown in FIG. 4 for a horizontal traveling of the arm 6, a further movement is limited by the tilt head 3 in the case shown in FIG. 6. This is already upwardly tilted in order not to crash against the lower arm 11 and can thus no longer be further inclined or panned. On a further extension of the arm 6 into a completely vertically extending position, the tilt head 3 and the lower arm 11 would come into contact so that the tilt head 3 would no longer be movable in this case.

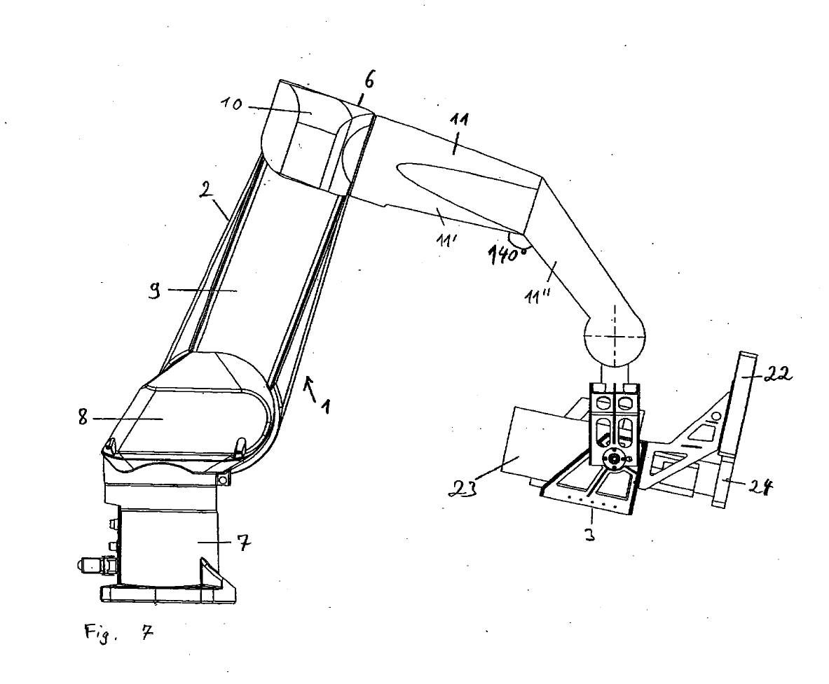

In the camera system 1 shown in FIG. 7 with camera robot 2 and tilt head 3, the design is therefore selected in accordance with one of the camera systems 1 shown in FIGS. 2 to 6. The lower arm 11 is now, however, divided into two segments, a first segment 11′ which is connected to the elbow joint 10 and a second joint 11″ which includes the wrist joint 5 at its end. The segment 11′ and the segment 11″ are connected to one another and are not movable with respect to one another. They are, however, tilted with respect to one another by an angle of 140° in the present case which is fixedly predefined by the shape of the lower arm 11. The angle can be between 110° and 190°, preferably, however, in the range from 130° to 160°. Due to the tilting by a fixed angle, the tilt head 3 is received in the space formed by the tilting when the arm 6 is traveled into high positions. The freedom of movement of the tilt head 3 is thus ensured over a larger range than before.

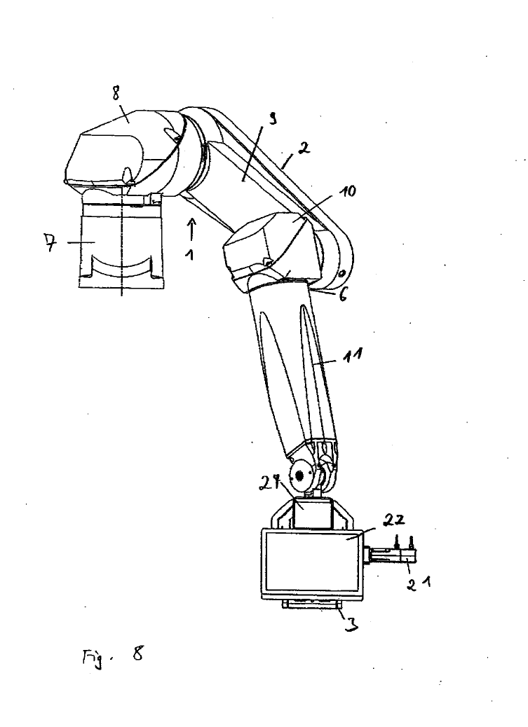

In FIG. 8, a camera system 1 in accordance with the one shown in FIGS. 2-6 can be seen. The camera robot 2 was rotated about a plurality of axes of rotation in this Figure and is located in a low position, with the tilt head 3 being located beneath the base unit 7. The tilt head 3 is panned as in FIG. 5 so that the camera lens 24 and the screen 22 face a viewer. The camera lens 24, and thus naturally also the camera 23, are located above the screen 22. The screen 22 is fastened to the tilt head 3 by a rack which can be mounted and removed simply by a screw connection or clamping connection and can accordingly be fastened above or below the camera 23.

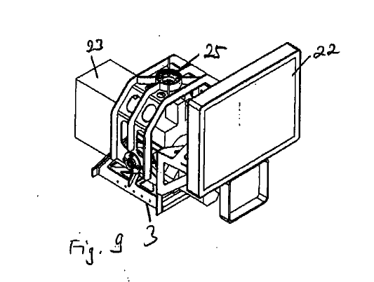

In FIG. 9, a tilt head 3 is shown in a perspective view with a screen 22 and a camera 23 arranged below the screen 22. The tilt head 3 comprises a frame of metal, preferably steel or aluminum, which surrounds the camera 23. The tilt motor 21 covered by the screen 22 here is attached to a side of the frame.

In an embodiment not shown in FIG. 9, the tilt head 3 can also include an apparatus which allows the camera 23 to rotate axially and to carry out the camera function “roll”. This apparatus is fastened to the frame of the tilt head 3 by a screw connection or clamping connection.

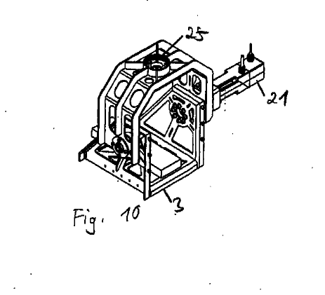

FIG. 10 shows a tilt head 3 with a tilt motor 21 without a camera or screen in a perspective view. The frame can be recognized here which can be connected to the flange 4 by a connection 25 at the upper side. The tilt motor 21 is connected to lower part of the frame which is connected to the upper part by screw or clamping connections and can be separated quickly therefrom. Defective cameras, for example, can thereby be replaced fast and without problem without the tilt head 3 having to be separated from the flange 4.

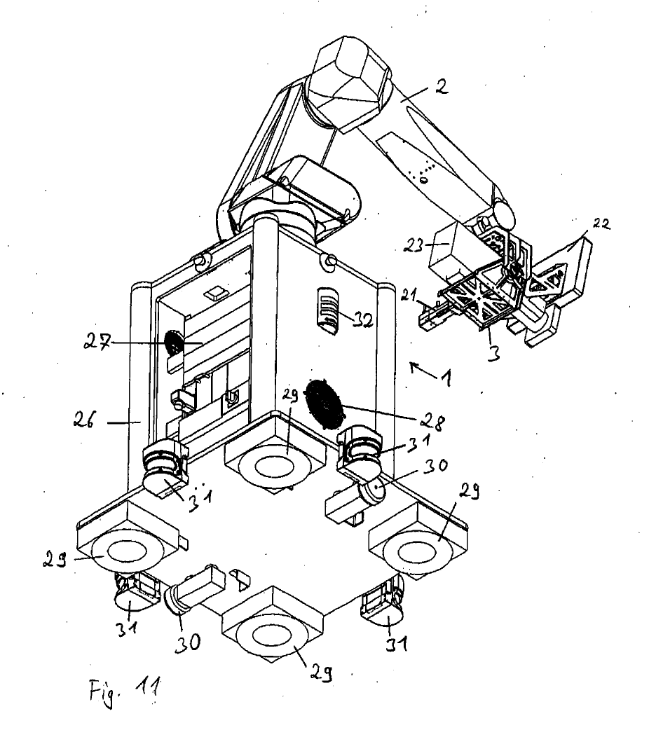

In FIG. 11, a further camera system 1 is shown from below in a perspective view. The camera system 1 in turn includes a camera robot 2 in accordance with the one shown in FIG. 1 as well as a tilt head 3 with a camera 23 and screen 22. The base unit 7 of the camera robot 2 is now, however, mounted on a movable platform 26 by a screw connection. Alternatively, the base unit 7 can also be clamped onto the movable platform 26.

The movable platform 26 includes a control unit 27 within its housing and said control unit is cooled by a fan 28 located at the side of the housing of the movable platform 26. Control units which are each designed to control a motor of an axis of rotation and which are not shown in FIG. 11 are located within the control unit 27. In the embodiment shown, the control unit 27 therefore includes six such controls. The controls are controlled and synchronized via a processor likewise comprised by the control unit 27. A synchronization of the movements about the axes of rotation is thus also achieved by the central control by a processor. The control unit 27 is configured such that the angle sum of the second axis of rotation 13, of the third axis of rotation 14 and of the fourth axis of rotation 15 is always kept constant. The control unit 27 moreover has the effect that the fifth axis of rotation 16 extending through the end of the arm 6 is always vertically aligned.

The movable platform 26 has four air cushions 29 on its lower side which, on the one hand, facilitate the movement of the movable platform 26 by the sliding on an air cushion, but, on the other hand, also act as vibration dampers. Instead of four air cushions 29, only one single correspondingly larger air cushion can also be used. In addition, a spring mechanism for vibration damping is included which is not visible in FIG. 11 due to its position in the interior of the movable platform 26.

Two wheels 30 by which the movable platform 26 can be moved are likewise located on the lower side of the movable platform 26. The wheels 30 are automatically controllable by the control unit 27. A free movement in space can be ensured by the provision of more wheels. In a particularly advantageous manner, the wheels 30 are so-called Mecanum wheels with which the speed of rotation and the direction of rotation can be individually controlled.

Finally, sensor elements 31 are attached to the lower side of the movable platform 26. These sensor elements 31 are part of a safety system and detect the presence of persons or objects in the panning or movement region of the camera system 1 via ultrasound. Optical sensors, for example laser sensors, can also be used instead of ultrasound sensors. The safety system constantly scans the environment via the sensor elements 31 and stops a movement of the camera system 1 via the control unit 27 as soon as a person has been detected in the monitored zone in order to preclude injury to the person and damage to the camera system 1. If an object is detected in the monitored zone by the sensor elements 31, the movement of the camera system 1 can likewise be stopped. This can additionally also be displayed by flashing of the warning lamp 32 attached to the housing of the movable platform 26 or by an acoustic signal.

The sensor elements 31 can also be used for checking and retracing predefined travel routes of the movable platform 26 in that the spacing from defined objects is measured using said defined objects and the movement of the camera robot 2 is controlled so that a specific distance from the objects or markings selected as reference points is reached and thus a predefined route is traveled. A localization of the movable platform 26 and thus of the camera robot 2 can thus also take place via the sensor elements 31. The sensor elements 31 can also include radio sensors for this purpose.

In an embodiment not shown, an extendable stand can also be included on a base surface at the lower side of the movable platform 26 for the fixed positioning of the movable platform 26 and it can be withdrawn again for movement. For fixing, the stand can include suction cups for positioning on a fixing surface or a magnetic fixing system for positioning on magnetic fixing surfaces.

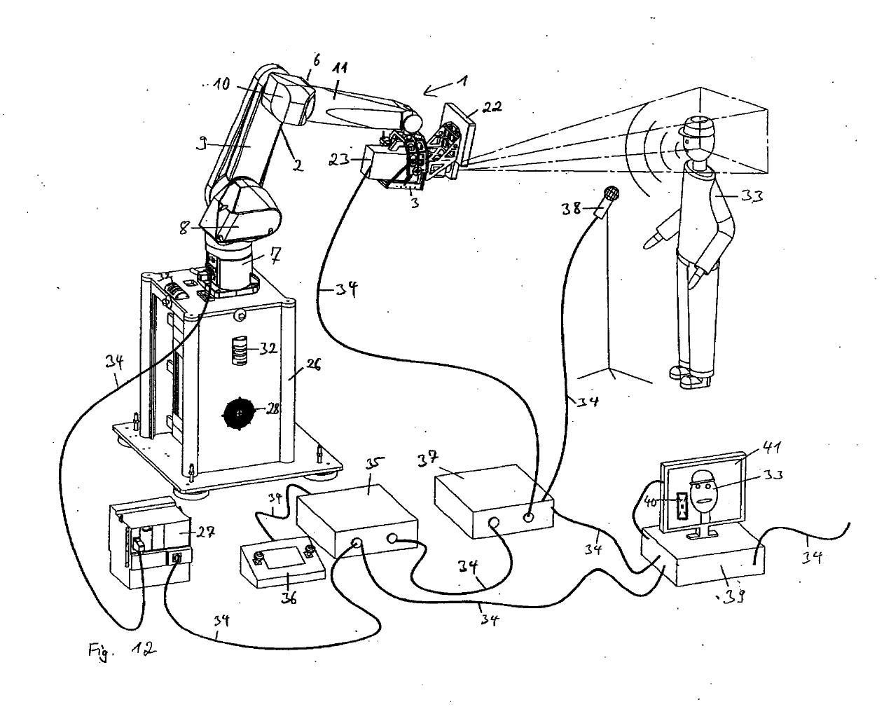

In FIG. 12, a camera system 1 is shown during a taking situation. The camera 23 is directed toward a presenter 33 for this purpose by corresponding movement of the camera robot 2 about its axes of rotation and traveling of the movable platform 26 and takes an image or film of him. The presenter 33 can for this purpose also read text off the screen 22 or be given stage directions over it. The camera robot 2 is controlled by a control unit 27 located outside the movable platform 26 in FIG. 12 which supplies the camera robot 2 with energy by a cable 34 and transmits control signals to the camera system 1 or receives feedback signals from it.

The control unit 27 is in turn controlled via a calculator unit 35 which is a PC in the embodiment shown. The calculator unit 35 is manually controllable via an operating device 36. The operating device 36 can include, as in the case shown, a joystick with which the movement of the camera robot 2 is set. A computer mouse, a keyboard or a trackball or touchpad can also be provided for this purpose. In the embodiment shown, two joysticks are provided at the operating device 36 by which different settings can be made. The control unit 27 and the calculator unit 35 are connected to one another like the operating device 36 and the calculator unit 35 via a cable 34.

The camera 23 transmits the images or films it has taken to a processing unit 37 via a cable 34. The processing unit 37 moreover receives audio data taken by a microphone 38 via a further cable 34. The audio data can include comments matching the taken film or commands for a voice control of the camera system 1. Movements of the camera robot 2 can be carried out or a taking of the camera 23 can be started or stopped by the voice control by certain spoken commands of the presenter 33. Provision can also be made to fade in a specific virtual object 40 on an image 41 completely mixed by a mixing unit 39 by the processing unit 37 by the voice control, for example, by speaking predefined keywords, to fade in the virtual object 40, that is, for example into the image of the presenter 33 taken by the camera 23. The virtual object 40 is thus synchronized with the real image.

The processing unit 37 carries out a voice recognition for this purpose and transmits control commands to the calculation unit 35 connected to the processing unit 37 via a cable 34 to move the camera robot 2. The calculator unit 35 and the processing unit 37 are moreover connected to the mixing unit 39 via a respective cable 34. The mixing unit 39 mixes the images received from the camera 23 with virtual objects 40 generated by the processing unit 37 so that the presenter 33 can be in any desired surroundings in the completely mixed image 41. The processing unit 37 can be connected via a further cable 34 to further processors which are not shown here and which transmit the image or further process it again.

Instead of the cable 34, a cableless connection can also be provided, for example via Bluetooth, for the data transmission.

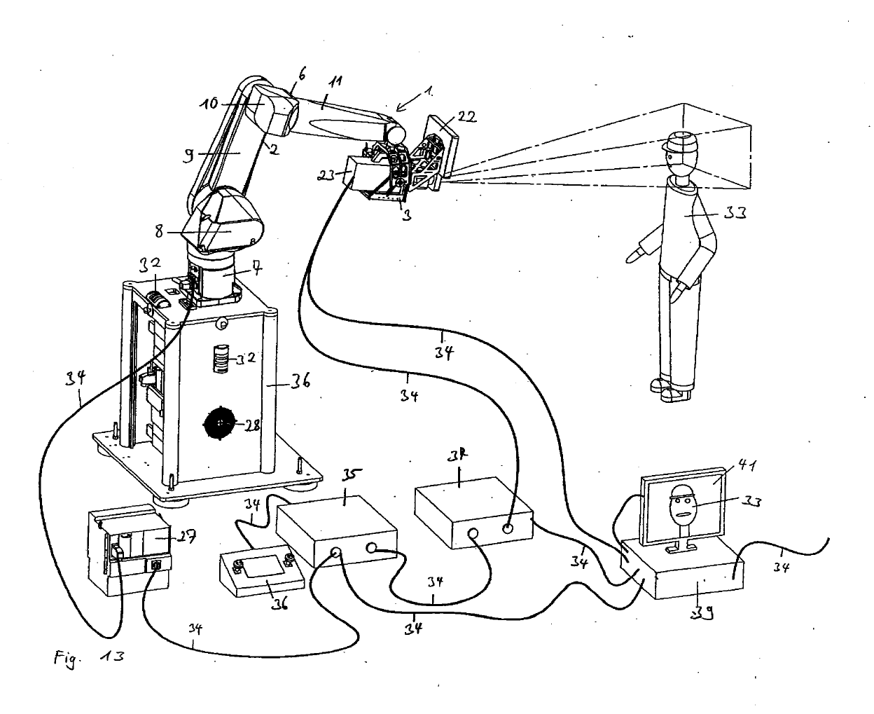

FIG. 13 represents a camera system 1 which corresponds to FIG. 12, but which no longer has an apparatus for taking acoustic signals and accordingly no longer has a voice control, but is rather instead controllable via a gesture of the presenter 33. The received signals are for this purpose examined in the processing unit 37 with respect to defined gestures and a movement signal is accordingly output to the camera robot 2. In turn, a virtual object not shown here can also be faded into the fully mixed image 41 via gestures of the presenter 33. In addition, the image taken by the camera 23 or the taken film can be transmitted directly to the mixing unit 39 which in turn mixes the image with a virtual environment.

Instead of the cable 34, a cableless connection can also be provided in this embodiment, for example via Bluetooth, for the data transmission.

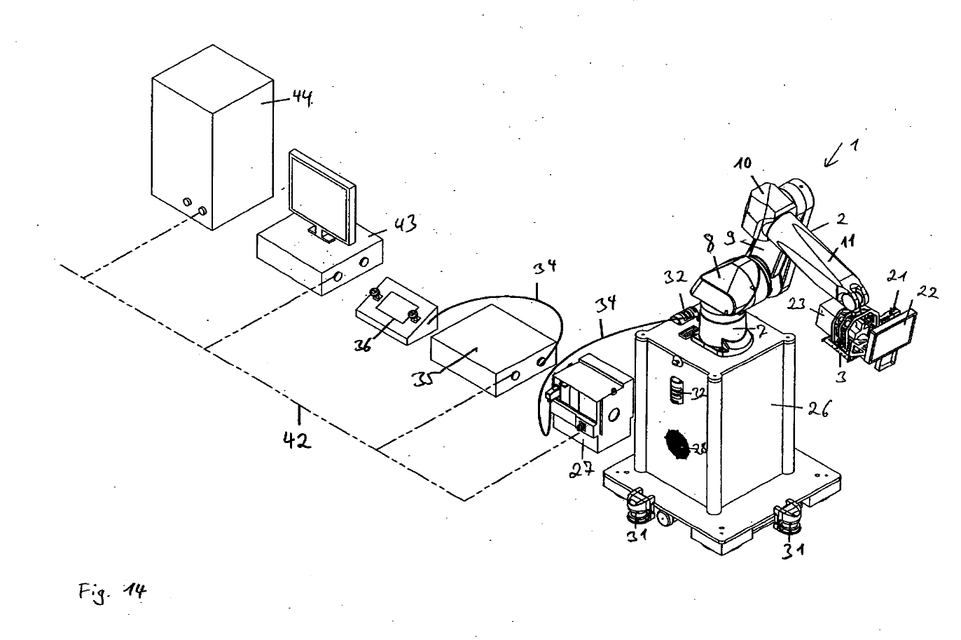

In FIG. 14, a camera system 1 having a camera robot 2, a tilt head 3 and a movable platform 26 is shown on which the camera robot 2 is mounted. A control unit 27 which is connected to the camera robot 2 via a cable 34 is located outside the movable platform 26. The control of the control unit 27 can take place via different connections 42, for example a network cable or a radio connection. The control unit 27 can therefore, for example, as shown in FIGS. 12 and 13, be connected to a calculator unit 35 and to an operating unit 36. Alternatively or in a complementary manner to the calculator unit 35, a server 43 can also be used on which not only trajectories of the camera robot 2 and desired values can be input as on the calculator unit 35, but also a graphical user interface can be provided for a virtual television studio. The desired values are transmitted at defined time intervals, for example every 4 ms, to the camera robot 2, whereby a control in real time is made possible. As an alternative or complement to this, an external server 44 can also be provided. The camera system 1 can in particular also be remote controlled via the external server 44 so that no person has to be present during a recording to operate the camera system 1 or to carry out the recording. The camera system 1 is particularly preferably used in a so-called newsroom computer system for television news studios which includes at least one of the previously named individual devices, that is a control unit 27, a calculator unit 35, a server 43 and an external server 44.

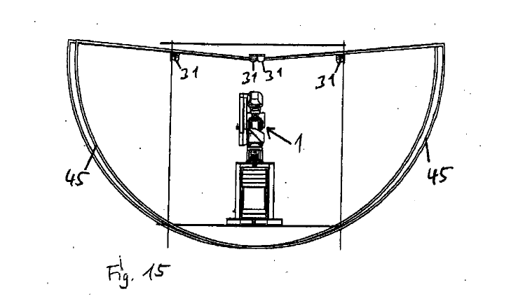

FIG. 15 shows a camera system 1 with a safety system in a side view. The sensor elements 31 of the safety system are not attached to the camera system 1, but are rather located at the ceiling of a studio. The sensor systems are laser based, but can also include ultrasound sensors and cover an angular range 45 of 190°. The environment of the camera system 1 is completely monitored by four sensor elements 31 which each monitor a specific angular region and the movement of the camera system 1 or the recording is stopped as soon as persons are present in the monitored zone.

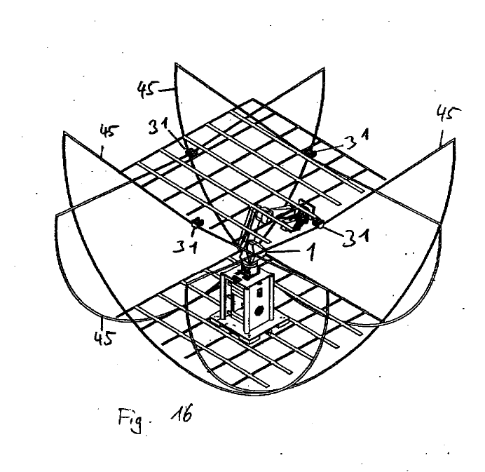

FIG. 16 is a perspective representation of the camera system 1 with a safety system of FIG. 15. The radius of the angular region 45 amounts to 4 m; each of the sensor elements 31 covers an angular region 45 of 190°. The connection with the camera system 1 takes place via a radio connection, but can also be made by means of a cable.

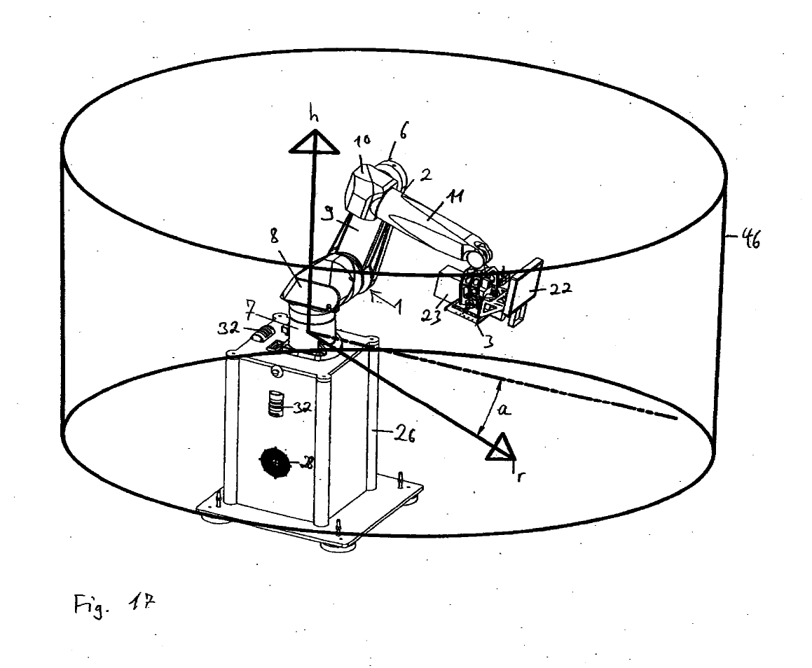

The coordinate systems used for controlling the camera robot 2 can include a Cartesian coordinate system, cylinder coordinate systems or spherical coordinate systems. In FIG. 17, a camera system 1 is shown with a camera robot 2 and a movable platform 26 corresponding to the embodiment shown in FIG. 11, but without sensor elements 31, in a cylinder coordinate system. Each spatial point can be exactly defined by a radius r, an angle a and a height h. The origin of the coordinate system shown lies in the base unit 7 and therefore represents the coordinate system of the camera robot 2. The spatial points which can be reached by the camera robot 2 lie within the spatial region bounded by the cylinder 46.

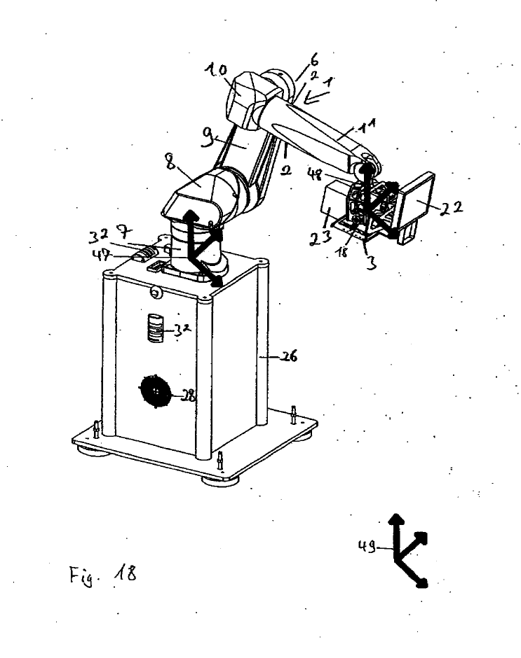

FIG. 18 represents a camera system 1 as in FIG. 17. The coordinate system used for controlling the camera robot 2 is now, however, a Cartesian coordinate system. The camera robot coordinate system 47 has its origin in the base unit 7. The origin of the tilt head coordinate system 48 is located at the point of intersection 18 of the fifth axis of rotation 16, of the sixth axis of rotation 17 and of the optical axis 19, particularly preferably on a CCD chip of the camera 23. In addition, a global coordinate system 49 is entered whose origin lies at any desired position outside the camera system 1, preferably, however, at the position on a ground at which the presenter 33 is standing.

For the simple controlling of the movement of the camera robot 2, a coordinate transformation is carried out between the camera robot coordinate system 47, the tilt head coordinate system 48 and the global coordinate system 49. For this purpose, the individual coordinate systems do not all have to be of the same type; however, this solution is particularly preferred to save computing power. The global coordinate system 49 moreover also serves to connect the virtual environment in which the images of the camera 23 can be inserted to the real world so that they can be linked to one another without problem.

What is claimed is:

1. A camera system having six axes of rotation for moving a camera, comprising: a camera robot and a tilt head for receiving a camera, wherein the camera robot has an arm having five axes of rotation and the tilt head is fastened to the arm by means of a flange, wherein the tilt head only has one axis of rotation and this axis of rotation is configured to tilt the camera.

2. A camera system in accordance with claim 1, wherein at least two of the five axes of rotation of the camera robot extend in parallel to one another.

3. A camera system in accordance with claim 2, wherein three of the five axes of rotation extend parallel to one another in the horizontal direction.

4. A camera system in accordance with claim 3, wherein the angle sum of the three axes of rotation extending parallel to one another in the horizontal direction is constant.

5. A camera system in accordance with claim 2, wherein two of the five axes of rotation extend parallel to one another in the vertical direction.

6. A camera system in accordance with claim 1, wherein two of the five axes of rotation extend through an end of the arm, with these two axes of rotation preferably being perpendicular to one another.

7. A camera system in accordance with claim 1, wherein the axis of rotation for tilting the camera and an axis of rotation extending in the vertical direction through the end of the arm are perpendicular to one another.

8. A camera system in accordance with claim 1, wherein the axis of rotation for tilting the camera and an axis of rotation extending in the vertical direction through the end of the arm intersect.

9. A camera system in accordance with claim 1, wherein the axis of rotation for tilting the camera lies in a focal plane of the camera received by the tilt head.

10. A camera system in accordance with claim 1, wherein the axis of rotation extending in the vertical direction through the end of the arm and the axis of rotation for tilting the camera intersect on the optical axis of a camera lens.

11. A camera system in accordance with claim 1, wherein the camera robot includes a base unit, a shoulder unit, an upper arm, an elbow joint and a lower arm, wherein the lower arm, the elbow joint and the upper arm form the arm, and wherein the shoulder unit is fastened rotatably about a first one of the axes of rotation on the base unit, the upper arm is fastened rotatably about a second one of the axes of rotation at the shoulder unit, the lower arm is fastened to the upper arm rotatably about a third one of the axes of rotation via the elbow joint, wherein the tilt head is fastened to the lower arm via a wrist joint with flange which is rotatable about a fourth one of the axes of rotation and a fifth one of the axes of rotation and which is located at the end of the arm.

12. A camera system in accordance with claim 11, wherein the lower arm includes two segments which are connected to one another and are tilted by a fixed angle with respect to one another.

13. A camera system in accordance with claim 1, wherein the camera robot each has a preferably brushless motor for a rotation about a respective one of the axes of rotation.

14. A camera system in accordance with claim 1, wherein the first axis of rotation and the fifth axis of rotation extend in the vertical direction and/or the second axis of rotation, the third axis of rotation and the fourth axis of rotation extend in the horizontal direction.

15. A camera system in accordance with claim 1, wherein the camera system includes a control unit which respectively has a control for controlling each of the motors and a processor for controlling the controls.

16. A camera system in accordance with claim 15, wherein the control unit is configured to keep the angle sum of three axes extending in parallel constant.

17. A camera system in accordance with claim 16, wherein the control unit is configured to ensure a vertical position of a further axis extending through the end of the arm.

18. A camera system in accordance with claim 1, wherein the camera system includes a movable platform on which the camera robot is mounted.

19. A camera system in accordance with claim 18, wherein the movable platform includes the control unit.

20. A camera system in accordance with claim 18, wherein the movable platform has an air cushion.

21. A camera system in accordance with one of the claim 18, wherein the movable platform includes at least two preferably automatically controllable wheels.

22. A camera system in accordance with claim 1, wherein the camera system has a safety system which is designed to keep a safety distance of the camera system from other objects.

23. A camera system in accordance with claim 1, wherein a screen is attached to the tilt head.

24. A camera system in accordance with claim 1, wherein the camera system has an apparatus for receiving and processing gestures of a user, with the camera robot being controllable by the gestures.

25. A camera system in accordance with claim 1, wherein the camera system has a device for receiving and processing acoustic signals, with the camera robot being controllable by the acoustic signals.

26. A camera system in accordance with claim 1, wherein the camera system has an operating unit, preferably a joystick, for controlling a movement of the camera robot.

27. A camera system in accordance with claim 1, wherein the camera system is controllable via a remote control.
